(19) United States
(12) Patent Application Publication
(10) Pub. No.: US 2016/0060154 A1
(43) Pub. Date: Mar. 3, 2016

(54) BURNERS FOR SUBMERGED COMBUSTION

(71) Applicant: CORNING INCORPORATED, Corning, NY (US)

(72) Inventors: Curtis Richard Cowles, Corning, NY (US); Dale Robert Powers, Painted Post, NY (US)

(21) Appl. No.: 14/768,840

(22) PCT Filed: Feb. 26, 2014
(86) PCT No.: PCT/US14/18556

§ 371 Date: Aug. 19, 2015

Related U.S. Application Data
(60) Provisional application No. 61/770,593, filed on Feb. 28, 2013.

(51) Int. Cl. C03B 5/235; F23D 14/24; C03B 5/04; F23C 3/00

(52) U.S. Cl. CPC C03B 5/2356; F23C 3/004; F23D 14/24; C03B 5/04; C03B 2211/23

(57) ABSTRACT

A burner for submerged combustion melting that mixes a first gas and a second gas inside the burner and emits the mixed gas through a nozzle for combustion below the surface of the material being melted. The burner includes a hollow tube and a static mixer inside the tube that mixes the first gas and the second gas as they travel through the tube. The mixed first and second gas exits a nozzle on a top end of the tube and is ignited to generate a flame below the surface of the material being melted, which may be a glass material.

This application claims the benefit of priority to U.S. application Ser. No. 61/770,593 filed on Feb. 28, 2013 the content of which is incorporated herein by reference in its entirety.

### FIELD

This disclosure relates to submerged combustion melting. More specifically, this disclosure relates to burners for submerged combustion melting, and more particularly to burners for submerged combustion melting that mix the oxidant with the fuel gas inside of the burner.

### BACKGROUND

In a conventional glass melter the burners are located above the surface of the glass materials in the melter (e.g. the glass batch materials and later the melted glass materials, or collectively the “glass melt”) and are directed down toward the top surface of glass melt. In an effort to increase the thermal efficiency of glass melters the burners have also been located below the surface of the melt and fired up into the glass melt in what has been referred to as submerged combustion melters (“SCM”s). In a SCM the flame and products of the combustion (primarily carbon dioxide and water) travel through and directly contact the glass melt, thereby transferring heat directly to the glass melt resulting in more efficient heat transfer to the glass melt than in conventional glass melters. More of the energy from the combustion is therefore transferred to the glass melt in an SCM than in a conventional glass melter. The flame and products of the combustion travelling through the glass melt in an SCM also agitate and mix the glass melt, thereby enabling the glass melt to be effectively mixed without the use of mechanical mixers that are typically required in conventional glass melters. The glass melt in a conventional glass melter is not significantly stirred by the presence of the burner and flame above the surface of the glass material without the aid of mechanical mixers. However, use of mechanical mixers in conventional glass melters is problematic. Due to the high temperature and corrosive nature of the glass melt, mechanical mixers in glass melters tend to be expensive and have a short useful life. As a mechanical mixer in a glass melter degrades, material from the mixer contaminates the glass melt. SCM can enable the glass melt to be melted and homogenized in smaller volumes and shorter times than in conventional glass melters. The improved heat transfer and smaller size of an SCM can lower energy consumption and capital costs compared to conventional glass melters.

A prior art SCM burner 10 is illustrated in FIG. 1. The illustrated SCM burner 10 includes two concentric tubes, a central tube 12 and an outer 14. The central tube 12 delivers fuel gas G to a nozzle 18. An annular space 16 between the tube 12 and the outer tube 14 delivers the oxygen O to the burner for combustion of the fuel gas G exiting the nozzle. The outer tube 14 forms part of a cooling jacket 13 that surrounds the inner and outer tubes 12 and 14. The nozzle 18 has a central gas outlet 22 and a plurality of outer gas outlets 24 (for example, as six holes) arranged in a ring around the central gas outlet 22. Passages leading to the outer gas outlets 24 are inclined outwardly from the longitudinal central axis of the central tube 12 at a gas exit angle A in a range from 25° to 65°. Oxygen exits the burner through an annular oxygen outlet 26 formed between the outer tube 14 and the central tube 12. The fuel gas exiting the gas outlets 24 along the gas exit angle is directed toward and mixes with the oxygen exiting the oxygen outlet 26 so that the gas combusts generating a flame (not shown) that is fired vertically upward into and through the glass melt (not shown). The prior art burner 10 of FIG. 1 is typically operated with the top of the nozzle 18 and the central tube 12 either flush with the top of the outer tube or recessed about 1½ inches below the top of the outer tube 14 (and the top end 28 of the burner) so that the gas can mix with the oxygen before reaching the top end 28 of the burner. Cooling fluid F is circulated through the cooling jacket 13 in order to cool the burner.

The flame travelling vertically though the glass melt in such a SCM from burner 10 as illustrated in FIG. 1 tends to entrain a large amount of the glass melt and spray the glass melt onto the sides the melter (not shown). Some of the entrained glass melt may even be sprayed into the air exhaust system of the melter. The entrained glass melt hardens on and coats the upper walls of the melter and the exhaust system, including observation ports, sensor locations, exhaust ducts, etc. The entrained molten glass material can also collected in and on the filter system of the pollution abatement system (bag house, filter, etc.), thereby fouling the filters. The combustion products may break through the surface of the glass melt in large “burps” that fling some of the glass melt upwards, which can result in the flinging of unmelted and/or insufficiently mixed molten glass material toward the glass exit of the melter called the tap (not shown). Occasionally some of this unmelted or insufficiently mixed glass melt may exit the tap with the desired fully melted and mixed glass melt, which is very undesirable. The high velocity of the combustion products in a typical SCM burner as illustrated in FIG. 1 can also result in the formation of a large number of gas bubbles in the melt. For many applications it is necessary to remove these gas bubbles in a “fining” stage. During fining, the glass melt must be held at a temperature high enough for the bubbles to rise in the glass melt for removal therefrom, creating a large energy demand. Such a SCM burner may also generate a very loud piercing sound when operated with certain some glass compositions. The noise level can reach about 9-dB or 100 dB creating a major threat to operators' hearing unless both ear plugs and ear muffs are worn.

### SUMMARY

One aspect of the present disclosure pre-mixing the fuels and the oxidant in the burner prior to entry into the glass melt.

According to an aspect of the present disclosure, a burner for SCM is described that may include a hollow tube with a top end and a bottom end; a first gas supply line in communication with an interior of the tube for delivering a flow of a first gas through the tube and out the top end of the tube; a second gas supply line in communication with an interior of the tube for delivering a flow of a second gas through the tube and out the top end of the tube; and a mixer in the tube that mixes the first gas with the second gas as the first gas and second gas travel through the tube such that mixed gas is emitted out the top end of the tube.

The static mixer may include a plurality of vanes that mix the first gas and the second gas. Each of the plurality of vanes may approximates a portion of a helix may alternate between helically twisted right handed and helically left handed vanes. A leading edge and a trailing edge of adjacent vanes may be arranged substantially normal to one another.

In an alternative aspect hereof, the mixer may be a static mixer that causes the mixed gas to swirl as it exits the tube.

According to one aspect hereof, a nozzle may be provided on a top end of the tube. A plurality of gas outlets may pass through the nozzle into communication with an interior of the tube such that the mixed gas passes through the plurality of gas outlets and a plurality of mixed gas jets are emitted from the nozzle. According to one aspect hereof, the plurality of gas outlets may be slanted outwardly at an angle in a range from 25° to 65° relative to a longitudinal axis of the tube. The plurality of gas outlets may also be arranged in a circle around the longitudinal axis of the tube. The gas outlets may also be vertically inclined in a direction tangent to the circle. A static mixer as described above may be located in the tube for delivering mixed gas to the nozzle.

According to an alternative aspect hereof, the plurality of gas outlets may be arranged in a circle around the longitudinal axis of the tube and may each be formed as a segment of a conical or cylindrical helix. The gas outlets may also be slanted outwardly at an angle in a range from 25° to 65° relative to a longitudinal axis of the tube or be generally vertical. A static mixer as described above may be located in the tube and deliver mixed gas to the nozzle.

According to another aspect of the present disclosure, a SCM apparatus is described that may include a melting chamber for containing a molten pool, said melting chamber having an orifice formed in a wall thereof; and a burner positioned in the orifice to inject a flame into the melting chamber. The burner may include a hollow tube having a top end and a bottom end; a first gas supply line in communication with an interior of the tube for delivering a first gas through the tube and out the top end of the tube; a second gas supply line in communication with the tube for delivering a second gas through the tube and out the top end of the tube; and a mixer in the tube that mixes the first gas and the second gas traveling through the tube such that mixed gas is emitted out the top end of the tube. The mixer may be a static mixer that causes the mixed gas to swirl as it exits the tube. The mixer may be a static mixer that includes a plurality of vanes that mix the first gas and the second gas.

A nozzle may be located on a top end of the tube and a plurality of gas outlets may pass through the nozzle into communication with an interior of the tube such that the mixed gas passes through the plurality of gas outlets and a plurality of mixed gas jets are emitted from the nozzle. The plurality of gas outlets may be slanted outwardly at an angle in a range from 25° to 65° relative to a longitudinal axis of the tube and may be arranged in a circle around the longitudinal axis of the tube and are vertically inclined in a direction tangent to the circle. The plurality of gas outlets may alternatively be arranged in a circle around the longitudinal axis of the tube and may each be formed as a segment of a conical helix.

In another aspect of the present disclosure, a method of melting glass that may include the steps of supplying glass melt into a glass melting chamber; providing a flow of a first gas; providing a flow of a second gas that is combustible when mixed with the first gas; mixing the flow of first gas with the flow of second gas producing a flow of combustible mixed gas; emitting the flow of the mixed into the melting chamber below the surface of the glass melt in the melting chamber in manner that causes the flow of the mixed gas to expand as it enters the melting chamber; and igniting the mixed gas producing an expanding flame in the melting chamber below the surface of the glass melt and melting the glass melt. The process may also include the step of causing the mixed gas to swirl as it enters the melting chamber.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain views of the figures may be shown exaggerated in scale or in schematic in the interest of clarity and conciseness.

FIG. 1 is a cross-sectional side view of a Prior Art submerged combustion melter burner;

FIG. 2 is a partial cross-sectional side view of a burner for a submerged combustion melter according to a first embodiment hereof;

FIG. 3 is a perspective view of the nozzle of the burner of FIG. 2;

FIG. 4 is a top view of the nozzle of FIG. 3;

FIG. 5 is a cross-sectional view of the nozzle taken along line 5-5 in FIG. 4;

FIG. 6 is a cross-sectional view of the nozzle taken along line 6-6 in FIG. 4;

FIG. 7 is a perspective view of a second embodiment of a nozzle for use with the burner of FIG. 2;

FIG. 8 is a top view of the nozzle of FIG. 7;

FIG. 9 is a cross-sectional view of the nozzle taken along line 9-9 in FIG. 8;

FIG. 10 is a cross-sectional view of the nozzle taken along line 10-10 in FIG. 8;

FIG. 11 is a cross-sectional view of the nozzle taken along line 11-11 in FIG. 8; and

FIG. 12 schematically illustrates a submerged combustion melting system including the burner apparatus of FIGS. 2-10.

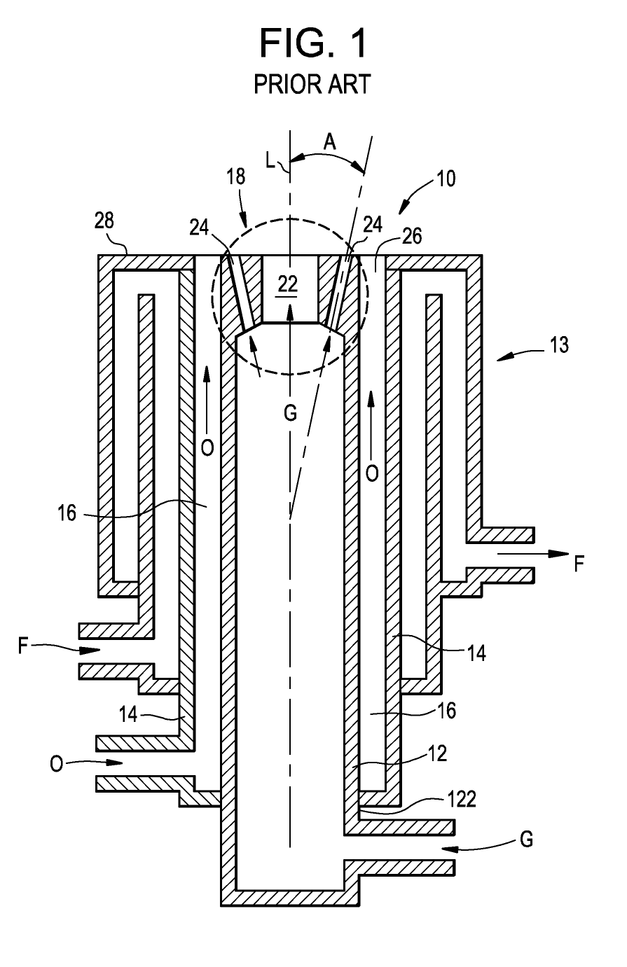

### DETAILED DESCRIPTION

The invention will now be described in detail with reference to a few embodiments thereof as illustrated in the accompanying drawings. In describing the embodiments, numerous specific details are set forth in order to provide a thorough understanding of the invention. However, it will be apparent to one skilled in the art that the invention may be practiced without some or all of these specific details and with additional or alternative details or features not described in detail herein. In other instances, well-known features and/or process steps have not been described in detail so as not to unnecessarily obscure the invention. In addition, like or identical reference numerals are used to identify common or similar elements.

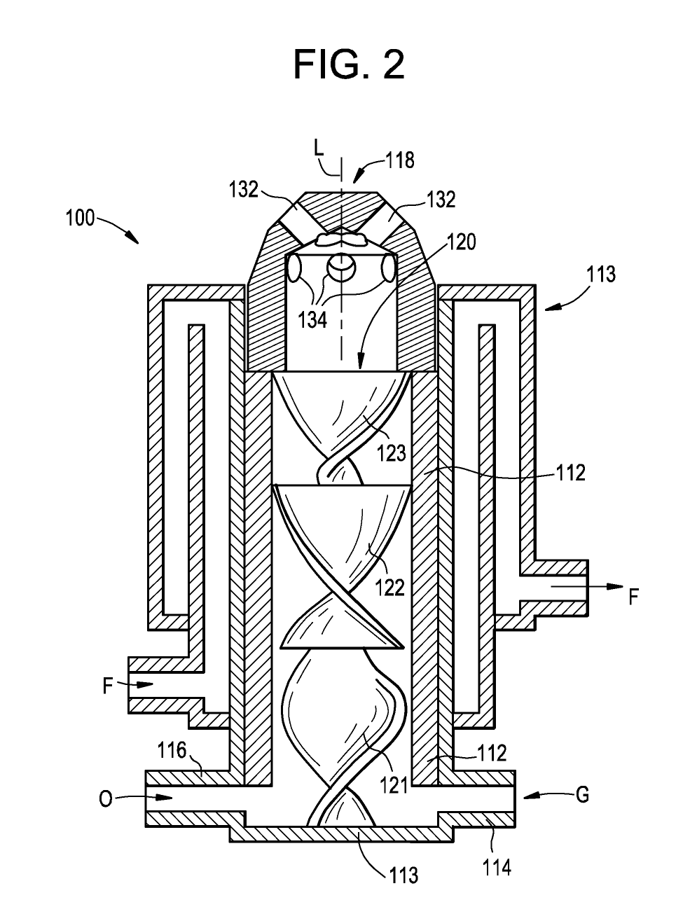

As illustrated in FIG. 2, a burner 100 for a SCM according to a first embodiment of the present disclosure includes a hollow tube 112 with a closed bottom end 113. The tube 112 includes a first port 114 and a second port 116 near the bottom end 113 that are in communication with the interior of the tube 112. In other embodiments, one or more of the first port 114 and the second port 116 may be located in the closed bottom end 113 of the tube 112. A nozzle 118 is mounted to or formed in the top end of the tube 112. A static mixer 120 is located in the tube 112 between the first and second ports 114, 116 and the nozzle 118. The static mixer 120 is configured to mix the first gas with the second gas as the first gas and second gas travel through the tube and through the static mixer.

An external source of a first (not shown), e.g., a source of fuel gas, such as natural gas, can be connected to the first port 114 by a first gas supply line or conduit (not shown) in order to supply a flow of the first gas to the tube. An external source of a second gas (not shown), e.g., a source of oxidant gas, such as oxygen, can be connected to the second port 116 by a second gas supply line or conduit (not shown) in order to supply a flow of the second gas to the tube 112. As is well understood in the art, a flow regulator (not illustrated) controls the flow of the first gas and the flow of the second gas to be at a desired first pressure and first flow rate and a desired second pressure and second flow rate, respectively. Cooling fluid F is supplied to the cooling jacket 113.

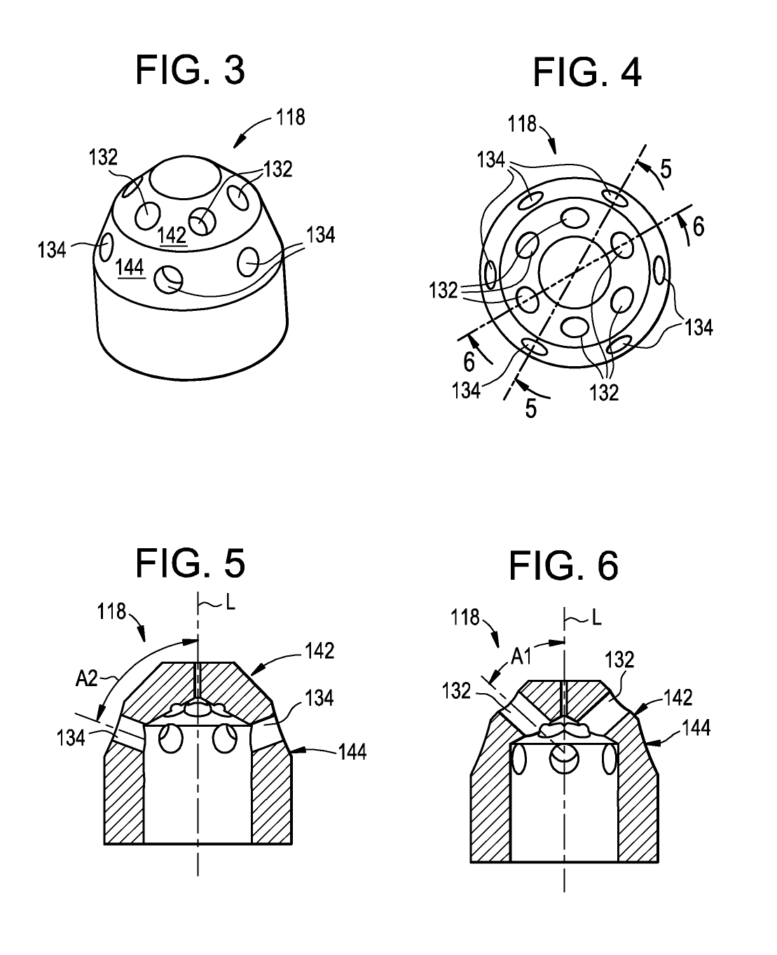

As best seen in FIGS. 3-5, according to one embodiment hereof the nozzle 118 may have a plurality of inner or first gas outlets 132 (for example, six outlets) arranged in a first ring around the central axis of the tube 112 and a plurality of outer or second gas outlets 134 (for example, six outlets) arranged in a second ring around the central axis of the tube 112. The first gas outlets 132 may be inclined outwardly from a central axis of the tube 112 at a first egress angle A1 of about 45° (see FIG. 6). Likewise, the second gas outlets 134 may be inclined outwardly from a central axis of the tube 112 at a second egress angle A2 of about 70° (See FIG. 5).

The nozzle 118 is illustrated with the first gas outlets 132 located in a first frustoconical section 142 of the nozzle 118 that is normal to the first egress angle A1 (but may alternatively be at an angle relative to the first egress angle) and a the second gas outlets 134 located in a second frustoconical section 144 of the nozzle 118 that is normal to the second egress angle A2 (but may alternatively be at an angle to the second egress angle). However, the nozzle 118 may alternatively have just a single frustoconical section that includes both the first and second gas outlets. Alternatively, the nozzle my simply be a cylindrical extension of the tube 112, with the first and second gas outlets being located in the outer peripheral surface of the nozzle. In another alternative embodiment, there may be a set of six to twelve first gas outlets only arranged in a single ring around the nozzle 118.

The first gas G and the second gas O travelling through the tube 112 are mixed by the static mixer 120 and a mixture of the first gas and the second gas exits the nozzle 118 through first and second gas outlets 132, 134 along the first and second egress angles A1 and A2. The mixed gas exiting the nozzle is ignited generating flames. The flames travel away from the nozzle within the glass melt along the first and second egress angles A1 and A2, such that the flames flare out away from the central axis of the tube. This flaring of the flames causes the momentum of the combustion gases to be more horizontal, diffused and spread out in the glass melt compared to typical prior art SCM burners, thereby reducing the vertical velocity and momentum of the combustion gases travelling through the glass melt and reducing the flinging of the glass compared to typical SCM burners. A burner that produces an intense flame near the nozzle can also help reduce or eliminate formation of a cold finger in the molten pool and avoid freezing of the glass melt at the point where the flame is injected into the glass melt.

The static mixer 118 may take any of a variety of configurations. According to an embodiment hereof illustrated in FIG. 2, the static mixer 118 is a one piece, helical twist static or motionless mixer (or simply helical static mixer), as can be purchased from StaMixCo, LLC for example. The helical static mixer 118 is formed of a plurality of helical baffles or vanes (for example three vanes 121, 122, and 123) that extend diametrically across the inner diameter of the tube 112 and are helically curved or twisted symmetrically about the longitudinal axis L of the tube 112. The vanes are alternatively helically twisted right handed (vanes 121, 123) and left handed (vane 122). The leading and trailing edges of adjacent vanes are substantially normal to one another. Static mixers with non-helical vanes that cause turbulence in the gases flowing through the static mixer may also be employed. For example, a Westfall Model 3050 static mixer manufacture by the Westfall Manufacturing Company may be employed. Static mixers with vanes that approximate a helix, such as a Low pressure Drop static mixer manufactured by Ross Engineering having flat, inclined, non-curved vanes arranged similar to the curved vanes 121, 122 and 124 illustrated in FIG. 2, may also be employed.

In operation, the first gas G and the second gas O are introduced into the tube 112 on opposite sides of the lead or first vane 121 of the static mixer 120. The leading edge of the second vane 122, which is arranged normal to the trailing edge of the first vane 121, splits the flow of the first gas G in two and splits the flow of the second gas O in two. Half of the first gas and half of the second gas are mixed on a first side of the second vane 122, while the other half of the first gas and the other half of the second gas are mixed on a second side of the second vane. In the same manner, the leading edge of the third vane 123 then splits and mixes the flows of mixed gas exiting the second vane 122 and further mixes the first gas and the second gas. More than three vanes maybe provided on the static mixer for enhanced mixing of the gases. The alternating helical motion and/or turbulence imparted to the gas by the vanes, along with repeated division and recombination of the gas flowing through the tube, effectively mixes the first gas with the second gas. In this manner the vanes cause a mixture of the first gas and the second gas to exit the static mixer 120, enter the nozzle 118, and exit the first and second gas outlets 132 and 134.

The tube 112, nozzle 118, static mixer 120 may be made of any suitable heat-resistant material, such as a stainless steel, e.g. 304, 312, or other high temperature stainless steel, austenitic nickel-chromium-iron alloys, e.g. Inconel®, a high temperature glass, such as fused silica, or a high temperature thermoplastic, such as polyvinylchloride or polyimide. The angle of the first gas outlets 132 and the second gas outlets 134 relative to the longitudinal axis of the tube may vary from 45° and 70°, respectively. For example, that first gas outlets may define a first egress angle in a range of from about 0° to about 75°, or about 45° from the central axis of the tube (e.g. from vertical), and the second gas outlets may define an egress angle in a range of from about 45° to about 90°, or about 70° from the central axis of the tube.

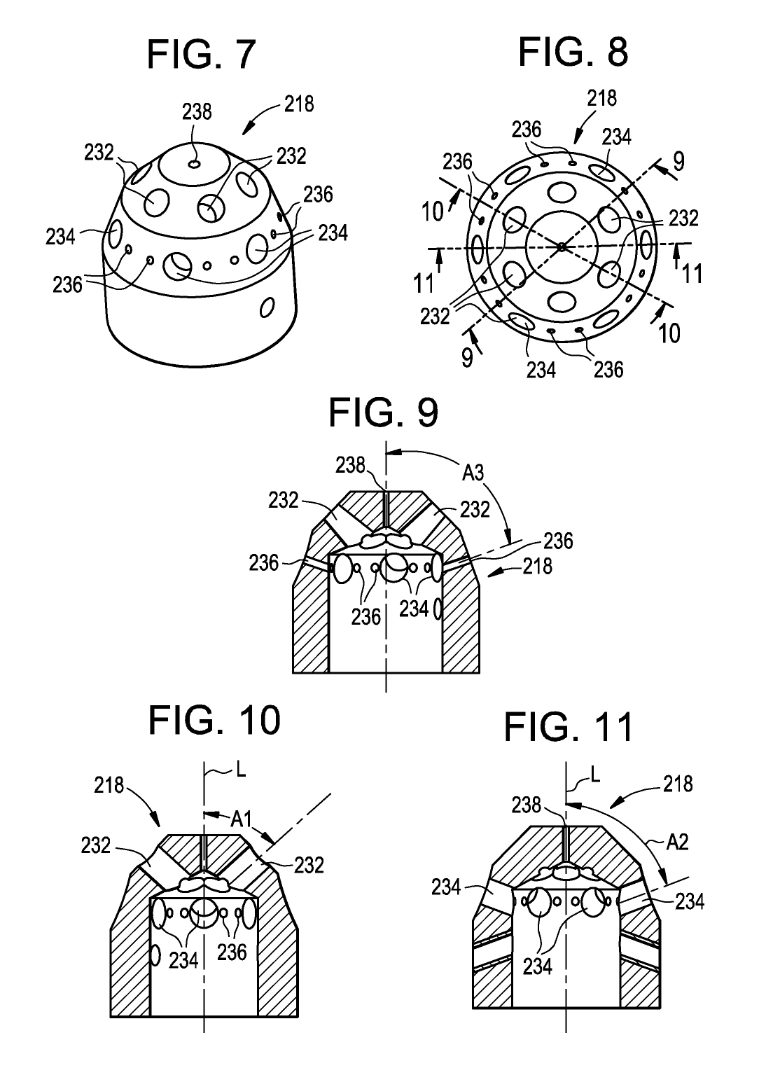

An alternative embodiment of a nozzle 218 for a burner 110 of the present disclosure is illustrated in FIGS. 7-11. Similar to the nozzle 118 of FIGS. 2-6, nozzle 218 has a plurality of inner first gas outlets 232 at a first egress angle A1 of about 45° and a plurality of outer second gas outlets 234 at a second egress angle A2 of about 70°. Nozzle 218 further has a plurality of relatively small pilot holes or gas outlets (for example, twelve small gas pilot holes 236) at an egress angle A3 of 70° from vertical (see FIG. 9). The nozzle 218 may optionally include an additional small pilot hole or gas outlet 238 in the top end of the nozzle that points vertically parallel to the longitudinal axis of the tube 112. The additional small pilot hole 238 may optionally be at an angle relative to vertical and may be offset from the vertical axis of the tube.

It is important that the gas mixture exits the gas outlets faster than the gas can burn. If the gas is moving slower than it burns, then the flame will “burn back” into the outlets and then back into the burner, potentially causing the burner to explode. A stoichiometric mixture of natural gas and oxygen will burn at a rate of about 3.4 m/s. Typically, the gas exits the gas outlet with a velocity profile that is not uniform. The gas near the wall of the gas outlet moves more slowly than the gas in the center of the outlet. Thus the average velocity must be higher than that value. If the gas outlet consists of a hole that has a significant length, then the velocity profile approaches a parabolic profile for laminar flow conditions. Burn back is partly inhibited by generating a quench layer near the wall of the outlets. As the gas burns near the walls of the gas outlet in the nozzle, some of the heat of combustion is lost into the metal or other material of the nozzle. This cooling of the flame near the walls of the gas outlet creates a “quench layer” around the outer periphery of the flame or gas mixture exiting the outlets that helps to extinguish or quench the flame. For a stoichiometric gas/oxygen mixture, the quench layer is only about 0.015 cm thick. Having the gas mixture move faster than the burning velocity is not required in this thin boundary area or quench layer. In any case, for a parabolic profile in a gas outlet of 0.25 cm diameter, the required velocity is 2.25 times the burning velocity. For turbulent flow conditions these relationships are more complicated. The velocity profile is steeper but the velocity is not constant. The steeper velocity profile reduces the requirement for having an average velocity significantly higher than the burning velocity. However, the variability of the velocity of gases in a turbulent flow increases the required average velocity. Increased pressure also increases burning velocity. To prevent burn back, a safety factor and have a minimum velocity of, for example, 30 m/s, maybe employed.

The majority of the mixed gas flows through the larger first and second gas outlets 234, 242 and a minority of the mixed gas flows through the smaller gas pilot holes or 236, which are used to generate pilot flames. The comparative velocity of the flow through the smaller and larger gas outlets depends on the diameter and length of the holes. For larger outlets/holes of 0.25 cm diameter and smaller pilot outlets/holes of 0.125 cm diameter, assuming the length of the holes is between 0.5 cm to 1.5 cm, the velocity through the pilot holes is only about 15 percent slower than the velocity of the gas through the larger holes. The smaller pilot holes 236 provide pilot flames that prevent flame blowout because the smaller, slower gas jets emitted from the smaller pilot holes 236 lose their momentum more rapidly than the larger, faster jets emitted from the larger gas outlet holes 232, 234. With this arrangement, the burner 218 has been found not to blow out, even with velocities through the larger holes 232, 234 of over 220 m/s. Prior art burners can blow out at high such high gas velocities when operated in air. The presently described burners must be optimized by balancing the size of the outlets and the rate/velocity of gas flowing through the outlets in order to avoid burn back of the combustion into the interior of the nozzle and tube.

In an alternative embodiment hereof (not illustrated), a SCM burner includes a static mixer 120 as illustrated in FIG. 2, but does not include a nozzle on the top end of the tube 112. The static mixer in such an arrangement extends to or near to the top of the tube. With this construction the first and second gas are mixed by the static mixer and the last vane of the static mixer causes the mixed to swirl as it exits the top of the tube. The result is a swirling, expanding flame.

In yet another embodiment, the static mixer is disposed of and a swirl inducing nozzle is provided on the top of the tube 112. Such a swirl inducing nozzle may have gas outlets, such as outlets 132 and 134 in FIG. 2 and outlets 232 and 234 in FIG. 7, that are not only inclined outwardly away from the longitudinal axis L of the but are also inclined in a direction tangent to a circle about the longitudinal axis L such that a clockwise or counter-clockwise swirl is imparted to the gases as they exit the nozzle. With this construction, the gases swirl, mix and combust outside of the burner producing a swirling, expanding flame. The gas outlets may alternatively each be formed as a segment of a helix in order to induce a swirl to the gases emitted by the nozzle. In order to ensure proper mixing of the first and second gases, a static mixer as previously described herein may be located inside the tube 112 and used in combination with a swirl inducing nozzle as described in this paragraph.

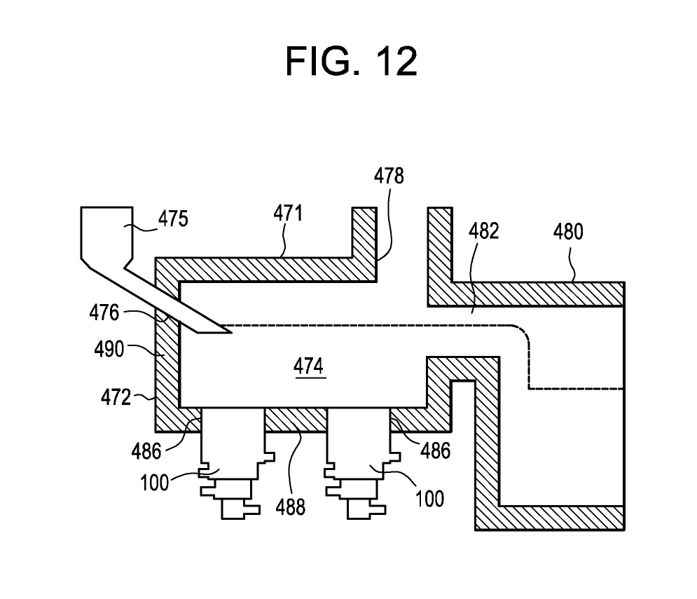

FIG. 12 shows a submerged combustion melting apparatus 471 including a melting chamber 472 containing a molten pool of glass melt 474. The melting chamber 472 includes a port 476 for feeding batch glass melt material from a hopper 475 into the melting chamber 472. The batch glass melt material may be provided in liquefied, particulate or powdered form. The melting chamber 472 also includes a port 478 through which exhaust gases can escape the melting chamber 472. The melting apparatus 471 also includes a conditioning chamber 480 connected to the melting chamber 472 by a flow passage 482. Molten glass melt material from the molten pool 474 flows from the melting chamber 472 to the conditioning chamber 480 through the flow passage 482 and then exits the melting apparatus 471. Orifices 486 are formed in the wall of the melting chamber 472. The orifices 486 are shown in the bottom wall 488 of the melting chamber 472. In alternate arrangements, the orifices 486 may be provided in the side wall 490 of the melting chamber 472. The orifices 486 may be perpendicular or slanted relative to the wall of the melting chamber 472. SCM burner apparatuses 100 are arranged in the orifices 486 to inject flames into the molten pool of glass melt 474.

Having a lower vertical component of momentum results in a reduced amount of glass melt being flung upwards in the melter. Another desirable feature of these SCM burners is more rapid combustion. Non-premixed flames (those flames in which the fuel and oxygen not premixed) are limited in their combustion rate by the rate these gases mix outside the burner. Premixed flames can burn faster because the burning velocities of mixtures are faster than the mixing rate of fuel and oxygen. More rapid combustion will allow more intense heat transfer in a smaller volume or area. This will allow more efficient heat transfer in a SCM system.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various burners for submerged combustion have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What is claimed is:

1. A burner for submerged combustion melting comprising:
a hollow tube having a top end and a bottom end;
a first gas supply line in communication with an interior of the tube for delivering a flow of a first gas through the tube and out the top end of the tube;
a second gas supply line in communication with an interior of the tube for delivering a flow of a second gas through the tube and out the top end of the tube; and
a mixer in the tube that mixes the first gas with the second gas as the first gas and second gas travel through the tube such that mixed gas is emitted out the top end of the tube.

2. A burner as in claim 1, wherein the mixer is a static mixer that causes the mixed gas to swirl as it exits the tube.

3. A burner as in claim 1, further comprising a nozzle on a top end of the tube and a plurality of gas outlets pass through the nozzle into communication with an interior of the tube such that the mixed gas passes through the plurality of gas outlets and a plurality of mixed gas jets are emitted from the nozzle.

4. A burner as in claim 3, wherein the mixer is a static mixer that includes a plurality of vanes that mix the first gas and the second gas.

5. A burner as in claim 4, wherein the plurality of gas outlets are slanted outwardly at an angle in a range from 25° to 65° relative to a longitudinal axis of the tube.

6. A burner as in claim 5, wherein the plurality of gas outlets are arranged in a circle around the longitudinal axis of the tube and are vertically inclined in a direction tangent to the circle.

7. A burner as in claim 5, wherein the plurality of gas outlets are arranged in a circle around the longitudinal axis of the tube and are each formed as a segment of a conical helix.

8. A burner as in claim 4, wherein the plurality of gas outlets are arranged in a circle around the longitudinal axis of the tube and are each formed as a segment of a helix.

9. A burner as in claim 4, wherein each of the plurality of vanes approximates a portion of a helix and the plurality of vanes alternate between helically twisted right handed and helically left handed vanes.

10. A burner as in claim 9, wherein a leading edge and a trailing edge of adjacent vanes are substantially normal to one another.

11. A submerged combustion melting apparatus, comprising:
a melting chamber for containing a molten pool, said melting chamber having an orifice formed in a wall thereof;
a burner positioned in the orifice to inject a flame into the melting chamber, the burner comprising:
a hollow tube having a top end and a bottom end;
a first gas supply line in communication with an interior of the tube for delivering a first gas through the tube and out the top end of the tube;
a second gas supply line in communication with the tube for delivering a second gas through the tube and out the top end of the tube; and
a mixer in the tube that mixes the first gas and the second gas traveling through the tube such that mixed gas is emitted out the top end of the tube.

12. A melting apparatus as in claim 11, wherein the mixer is a static mixer that causes the mixed gas to swirl as it exits the tube.

13. A melting apparatus as in claim 11, further comprising a nozzle on a top end of the tube and a plurality of gas outlets passing through the nozzle in communication with an interior of the tube such that the mixed gas passes through the plurality of gas outlets and a plurality of mixed gas jets are emitted from the nozzle.

14. A melting apparatus as in claim 13, wherein the mixer is a static mixer that includes a plurality of vanes that mix the first gas and the second gas.

15. A melting apparatus as in claim 13, wherein the plurality of gas outlets are slanted outwardly at an angle in a range from 25° to 65° relative to a longitudinal axis of the tube.

16. A melting apparatus as in claim 15, wherein the plurality of gas outlets are arranged in a circle around the longitudinal axis of the tube and are vertically inclined in a direction tangent to the circle.

17. A melting apparatus as in claim 15, wherein the plurality of gas outlets are arranged in a circle around the longitudinal axis of the tube and are each formed as a segment of a conical helix.

18. A method of melting glass comprising the steps of:
supplying glass melt into a glass melting chamber;
providing a flow of a first gas;
providing a flow of a second gas that is combustible when mixed with the first gas;
mixing the flow of first gas with the flow of second gas producing a flow of combustible mixed gas;
emitting the flow of the mixed into the melting chamber below the surface of the glass melt in the melting chamber in manner that causes the flow of the mixed gas to expand as it enters the melting chamber;
igniting the mixed gas producing an expanding flame in the melting chamber below the surface of the glass melt and melting the glass melt.

19. A method as in claim 18, further comprising the step of causing the mixed gas to swirl as it enters the melting chamber.
